(19) United States
(12) Patent Application Publication
(10) Pub. No.: US 2014/0133783 A1
(43) Pub. Date: May 15, 2014

(54) Sift-Resistant Bag

(71) Applicant: Graphic Packaging International, Inc., Atlanta, GA (US)

(72) Inventor: Doug Thurman, Crossett, AR (US)

(73) Assignee: Graphic Packaging International, Inc., Atlanta, GA (US)

(21) Appl. No.: 14/078,656

(22) Filed: Nov. 13, 2013

Related U.S. Application Data
(60) Provisional application No. 61/726,299, filed on Nov. 14, 2012.

(51) Int. Cl. B65D 51/24; B31B 29/00

(52) U.S. Cl. CPC B65D 51/24; B31B 29/00
USPC 383/59; 493/264

(57) ABSTRACT

A sift-resistant valve bag is disclosed herein. The bag includes an upper end, the upper end being at least partially closed, a lower end opposite the upper end, the lower end being closed, a valve in the upper end, the valve being configured to receive flowable material for filling the bag, and a patch in the upper end and opposite from the valve, the patch being configured to restrict leakage of material flowing through the valve, wherein the patch includes a cuff.

### CROSS-REFERENCE TO RELATED APPLICATIONS

This application claims the benefit of U.S. Provisional Patent Application No. 61/726,299, filed Nov. 14, 2012.

### INCORPORATION BY REFERENCE

The disclosure of U.S. Provisional Patent Application No. 61/726,299, which was filed on Nov. 14, 2012, is hereby incorporated by reference as if presented herein in its entirety.

### TECHNICAL FIELD

This disclosure relates to bags and, more particularly, to valve bags.

### BACKGROUND

It is well known to form bags from tubes, by closing ends of the tubes. One type of known bag may be referred to as a valve bag. Before a valve bag is filled with contents, the lower end of the bag may be closed, and the upper end of the bag may be closed except for a valve tube incorporated into the upper end of the bag. The bag may be filled by blowing flowable material through the valve tube. Then, the valve tube may be sealed closed.

Valve bags are typically filled with fine (e.g., small particles of) solid, flowable materials, such as dry powders, granules, pellets, and the like. In some instances, solid materials have leaked out of valve bags bag through small, unsealed passageways or channels that may be present at the ends of the bags. The upper ends of valve bags may be more susceptible to such leakage as a result of the bags being filled by way of their valve tubes. Accordingly, bags that are more sift resistant may be desirable.

### SUMMARY

One aspect of this disclosure is the provision of a sift-resistant (e.g., leak-resistant) bag, such as a sift-resistant valve bag. The bag has opposite upper and lower ends that are each closed, except that the upper end may include a closable valve tube for use in filling the bag. The upper end may further include an interior patch that is opposite from the valve tube, wherein the interior patch is configured for restricting any leakage of solid material from the upper end, such as when the bag is being filled via the valve tube. In an embodiment of this disclosure, the interior patch includes a fold-formed cuff extending crosswise (e.g., perpendicular) to the passageway through the valve tube, for restricting any leakage of solid material from the upper end, such as when the bag is being filled via the valve tube.

According to an additional aspect of the disclosure, a bag for containing flowable material is disclosed. The bag includes an upper end, the upper end being at least partially closed, a lower end opposite the upper end, the lower end being closed, a valve in the upper end, the valve being configured to receive flowable material for filling the bag, and a patch in the upper end and opposite from the valve, the patch being configured to restrict leakage of material flowing through the valve. Additionally, the patch includes a cuff.

According to an additional aspect of the disclosure, a method of forming a bag is disclosed. The method includes forming a sleeve having an interior from a web of multi-ply material, defining a plurality of upper and lower end flaps in the sleeve through a cutting process, folding the upper end flaps to form an upper end of the bag, folding the lower end flaps to form a lower end of the bag, positioning a valve on the upper end, and positioning a patch on the upper end and opposite from the valve. The valve is configured to receive flowable material for filling the bag and the patch is configured to restrict leakage of material flowing through the valve. Additionally, the patch includes a cuff.

According to yet another aspect of the disclosure, a bag for containing flowable material is disclosed. The bag includes a partially closed upper end, a closed lower end opposite the partially closed upper end, a valve in the upper end, and a patch in the upper end and opposite from the valve. The valve has a central axis aligned with a direction of flow of material for filling the bag and the patch is configured to restrict leakage of the flow of material. The patch includes a base portion and a cuff foldably connected to the base portion at a fold line. Additionally, the fold line is arranged transverse to the central axis of the valve

The foregoing presents a simplified summary of some aspects of this disclosure in order to provide a basic understanding. The foregoing summary is not an extensive summary of the disclosure and is not intended to identify key or critical elements of the disclosure or to delineate the scope of the disclosure. The purpose of the foregoing summary is to present some concepts of this disclosure in a simplified form as a prelude to the more detailed description that is presented later. For example, other aspects will become apparent from the following.

### BRIEF DESCRIPTION OF THE DRAWINGS

Having described some aspects of this disclosure in general terms, reference will now be made to the accompanying drawings, which may be schematic and are not necessarily drawn to scale:

FIG. 1 is a schematic pictorial view of a filled bag that includes a valve tube, wherein the valve tube is shown in an open configuration, in accordance with an embodiment of this disclosure.

FIG. 2 is a plan view of the front side of the bag of FIG. 1 in an unfilled, flattened configuration, with each of the ends in their closed configuration, and the closed ends folded over onto, and partially overlapping, a central body portion of the bag.

FIG. 3 is a plan view of the front side of a portion of a flattened tube from which the body of the bag of FIGS. 1 and 2 may be formed, wherein the tube includes fold lines as if the tube had been folded to form the bag in its unfilled, flattened configuration, and then unfolded.

FIG. 4 is a plan view of the rear side of the portion of the flattened tube of FIG. 3, wherein the tube includes fold lines as if the tube had been folded to form the bag in its unfilled, flattened configuration, and then unfolded.

FIG. 5 is like FIG. 3, except that upper end flaps of the tube are in a mount-ready configuration

FIG. 6 is like FIG. 5 (i.e., the upper end flaps are in the mount-ready configuration), except for schematically showing adhesive material by way of stippling.

FIG. 7 is like FIG. 6, except for showing the valve tube and a cuffed patch respectively mounted to the upper end flaps.

FIG. 8 is an isolated, top plan view of the cuffed patch.

FIG. 9 is a bottom plan view of the cuffed patch, wherein adhesive material is schematically illustrated by stippling.

FIG. 10 is an isolated plan view of the patch, wherein the patch is in a flat, unfolded configuration.

FIG. 11 is a schematic cross-sectional view of a portion of the bag taken along line 11-11 of FIG. 1, wherein contents of the bag are not shown.

FIG. 12 is a schematic cross-sectional view of a portion of the bag taken along line 12-12 of FIG. 2.

FIG. 13 is a schematic cross-sectional view of a portion of the bag taken along line 13-13 of FIG. 2.

### DETAILED DESCRIPTION

Exemplary embodiments of this disclosure are described below and illustrated in the accompanying figures, in which like numerals refer to like parts throughout the several views. The embodiments described provide examples and should not be interpreted as limiting the scope of the disclosure. Other embodiments, and modifications and improvements of the described embodiments, will occur to those skilled in the art and all such other embodiments, modifications and improvements are within the scope of the present disclosure.

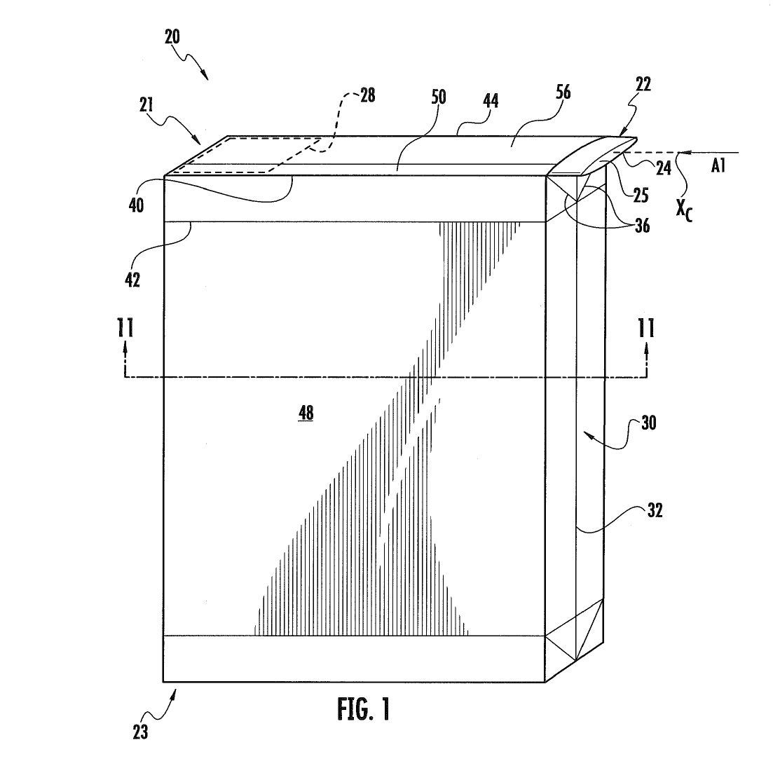

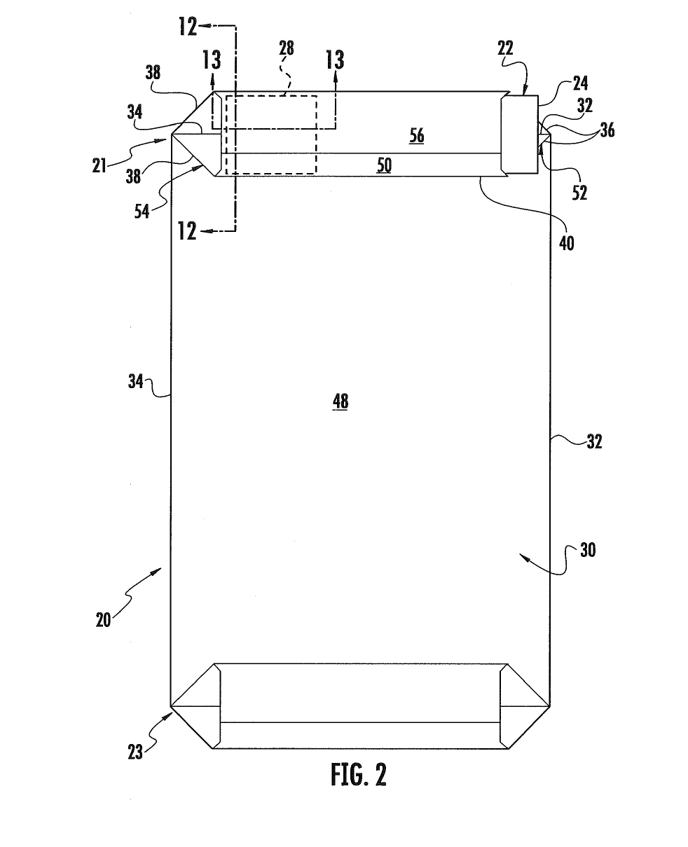

Referring now in greater detail to the drawings, in which like numerals refer to like parts throughout the several views, FIG. 1 illustrates a filled, sift-resistant (e.g., leak-resistant) valve bag 20, and FIG. 2 illustrates the bag in a empty, flat configuration. The bag 20 has opposite upper end 21 and lower end 23 that are each closed, except that the upper end includes a closable valve tube 22 for use in filling the bag. In FIG. 2, the closed ends 21, 23 are shown folded over onto, and partially overlapping, a central body portion of the bag 20.

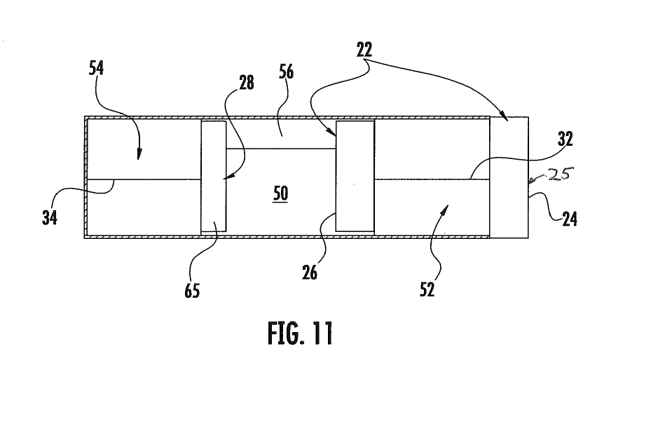

The valve tube 22 includes a passageway 25 that extends through the valve tube 22, from an outer end 24 of the valve tube to an inner end 26 (FIG. 11) of the valve tube 22. The valve tube 22 may include a central axis X_{C}. The outer end 24 of the valve tube 22 is open at the exterior of the bag 20 for receiving a nozzle (not shown) through which the bag is filled. The nozzle may direct flowable material into and through the valve tube 22 in a direction of flow represented by arrow Al. Generally, the flow of material Al and the central axis X_{C} may be aligned. The inner end 26 of the valve tube 22 is open to the interior of the bag 20 for allowing contents to flow through the valve tube into the interior of the bag. After the bag 20 is filled through the valve tube 22, the valve tube may be sealed closed in a conventional manner, such as with an adhesive material (not shown) positioned within the passageway 25 that extends through the valve tube. The adhesive material for closing the valve tube 22 may be a heat-activatable, thermoplastic adhesive material and/or the valve tube may be closed in any other suitable manner.

The upper end 21 of the bag 20 further includes an interior patch 28 that is opposite from the valve tube 22. The patch 28 is hidden from view in FIGS. 1 and 2; therefore, the patch is schematically illustrated by dashed lines in FIGS. 1 and 2. The patch 28 is configured for restricting any leakage (e.g., sifting) of solid material out of the bag 20 through the upper end 21 of the bag 20, such as when the bag is being filled via the valve tube 22, as will be discussed in greater detail below.

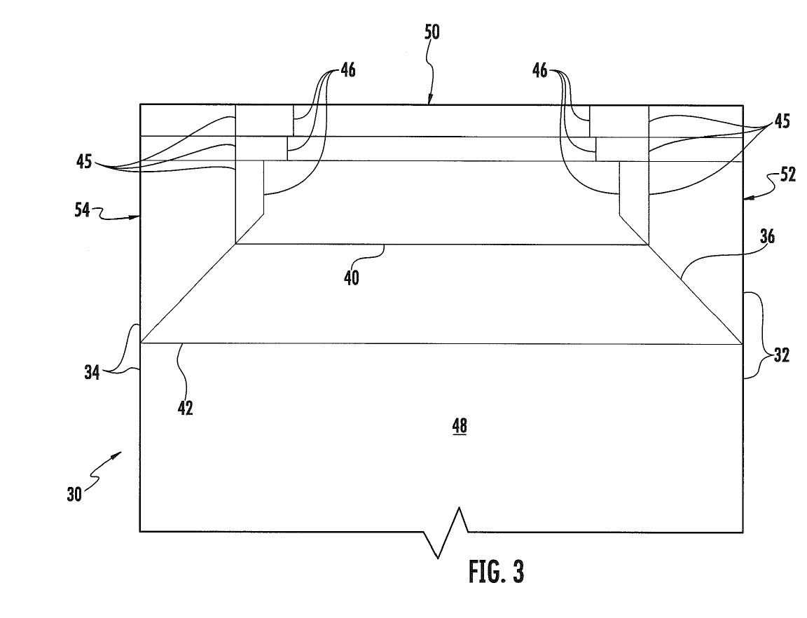

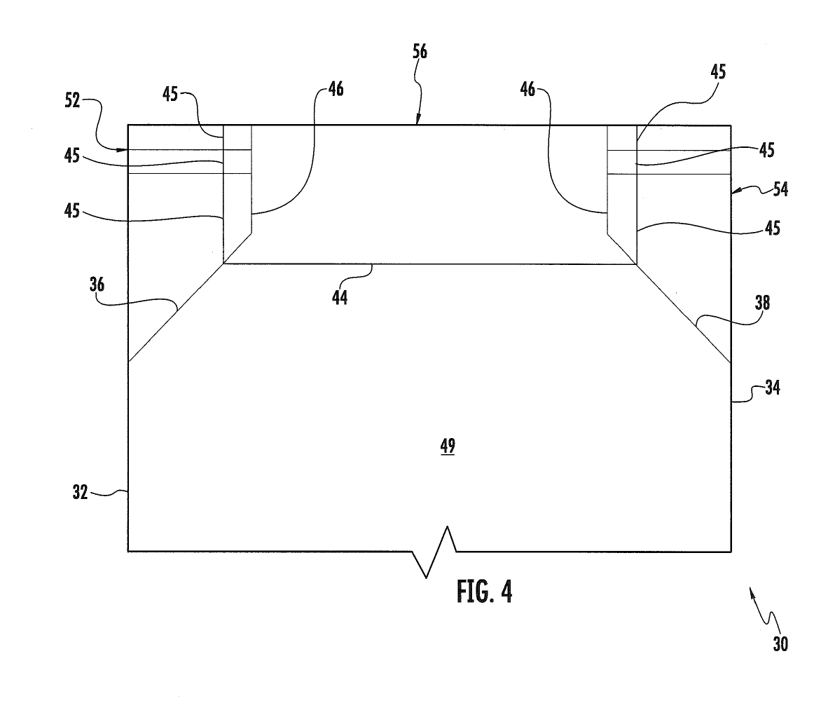

The bag 20 has a body formed from a body tube 30 (e.g., a sleeve), and a portion of the body tube is shown in isolation in FIGS. 3-5. FIGS. 3 and 4 are front and rear plan views of an upper portion of the flattened body tube 30. In FIGS. 3 and 4, the body tube 30 includes fold lines as if the body tube had been folded to form the bag 20 in its unfilled, flattened configuration, and then unfolded. In the drawings, only fold lines proximate the upper end 21 of the bag 20 and the body tube 30 are identified with reference numbers. The fold lines comprise right and left longitudinal fold lines 32, 34; pairs of right and left oblique fold lines 36, 38; a front upper lateral fold line 40; a front lower lateral fold line 42; a rear lateral fold line 44; and flap fold lines 45. The body tube 30 includes front and rear portions 48, 49 that are foldably connected to one another at the right and left longitudinal fold lines 32, 34.

In the embodiment illustrated in the drawings, the bag 20 is a multi-wall or multi-ply bag, and more specifically the body tube 30 has three plies that are each tubular. Each ply includes an longitudinally extending overlap seal (not shown). Each of the plies may be paper or any other suitable material for forming bags. FIGS. 3 and 4 show that the ends of the tubular plies have been “step-cut” (i.e., cut to different lengths) in a conventional manner (e.g., through a cutting process) at the upper end of the body tube 30. That is, the opposite top and bottom ends of the body tube 30 are step cut in a conventional manner. In addition, the plies have been respectively cut, or more specifically slit, so that the body tube 30 includes cuts, or more specifically longitudinal slits 46 (FIGS. 3 and 4). Alternatively and for example, the bag 20 and body tube 30 may include a greater or lesser number of plies, and they may be a single ply.

The step cuts, slits 46, and the oblique and lateral fold lines 36, 38, 40, 44 are cooperative so that the body tube 30 includes upper end flaps 50, 52, 54, 56 that are respectively foldably connected to one another by the oblique fold lines 36, 38. The front and rear end flaps 50, 56 may be referred to as header flaps. The right and left end flaps 52, 54 may be referred to as ear flaps. The body tube 30 includes fold lines 32, 34, 36, 38, 40, 42, 44, 45, step cuts, slits 46 and end flaps 50, 52, 54, 56 shown in FIGS. 3-5. Regarding the body tube 30 in its isolated state and flattened configuration, opposite ends of the body tube may be substantially the same. The lower end 23 of the bag 20 may be secured closed in a conventional manner, and may also include end flaps somewhat similar to upper end flaps 50, 52, 54, 56.

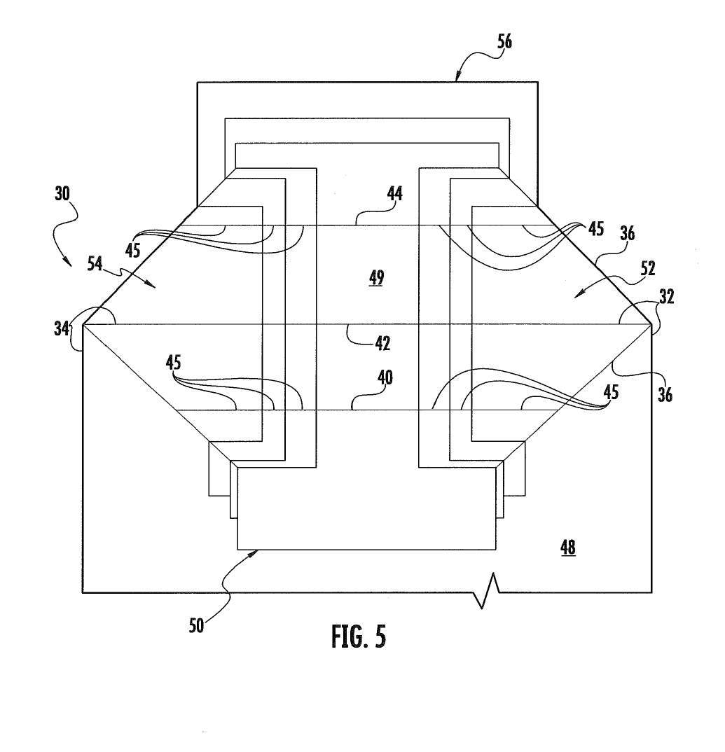

The upper end flaps 50, 52, 54, 56 are in a mount-ready configuration in FIG. 5. As shown in FIG. 5, the front end flap 50 has been folded downwardly about the front lower lateral fold line 42 through substantially one hundred and eighty degrees. Simultaneously with the folding of the front end flap 50, the right and left end flaps 52, 54 are folded inwardly about the oblique fold lines 36, 38 through substantially one hundred and eighty degrees.

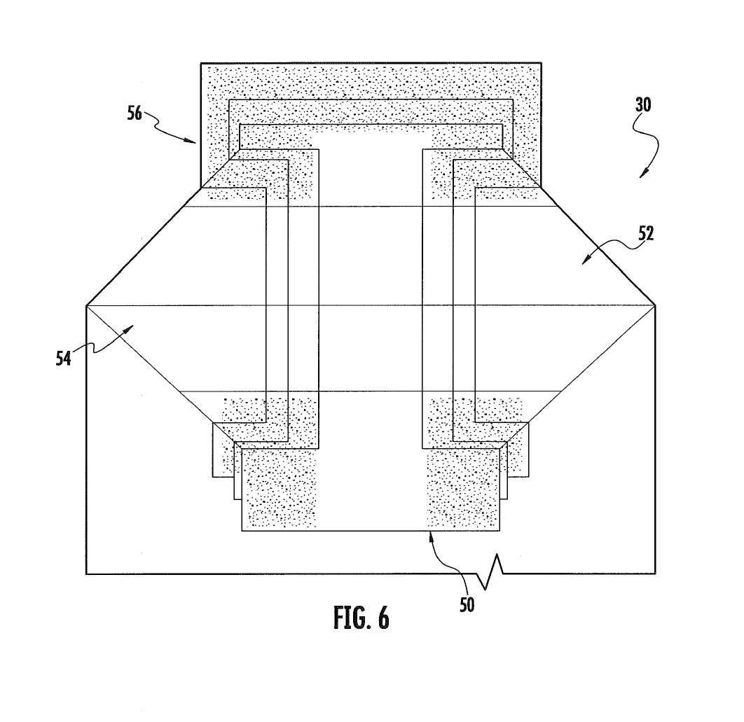

Referring to FIG. 6, adhesive material may be applied in a predetermined pattern to the end flaps 50, 52, 54, 56 while they are in the mount-ready configuration. The adhesive material is schematically illustrated by stippling in FIG. 6. The adhesive material may extend continuously, or intermittently, in the area of the adhesive pattern. The adhesive material may be of any suitable type, such as types conventionally used in the manufacture of paper bags. The adhesive material may be applied in any suitable manner, such as, but not limited to, through the use of a stamp that has the shape of the predetermined pattern and is temporarily engaged against the end flaps 50, 52, 54, 56 to deposit the adhesive material thereonto in the predetermined pattern.

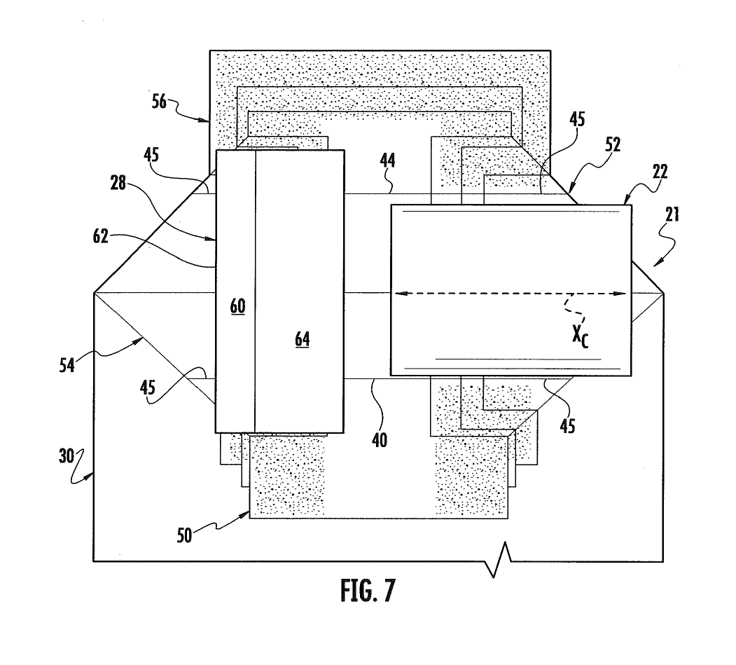

Referring to FIG. 7, the valve tube 22 may be mounted to the right end flap 52, and the patch 28 may be mounted to the front, left and rear end flaps 50, 54, 56, while the end flaps are in the mount-ready configuration (e.g., see FIG. 5). The valve tube 22 and the patch 28 may be mounted at any suitable time, such as, but not limited to, after the application of the adhesive material that is schematically illustrated by stippling in FIGS. 5 and 6. The valve tube 22 may be formed, then adhesive material may be applied to the underside thereof, and then the valve tube may be mounted in a conventional manner to the right end flap 52, such as, but not limited to, through the use of a conventional sleeve unit (not shown), as will be understood by those of ordinary skill in the art.

As shown in FIG. 7, the interior patch 28 includes a fold-formed cuff 60 extending crosswise (e.g., perpendicular, orthogonal, and/or transverse) to the passageway through the valve tube 22 (i.e., central axis X_{C}, arrow A1), for restricting any leakage of solid material from the upper end of the closed bag 20, such as when the bag is being filled via the valve tube 22, as will be discussed in greater detail below. In one embodiment, the cuff 60 is a marginal, relatively narrow, longitudinal strip of the patch 28 that is folded about a longitudinal fold line 62 in the patch relative to a base portion 64 of the patch. The cuffed patch 28 may be formed, then the cuffed patch may have adhesive material applied to the side of the base portion 64 that is opposite the cuff 66, and then the cuffed patch may be mounted in any suitable manner, such as, but not limited to, through the use of a sleeve unit (not shown) that has been configured accordingly. The valve tube 22 and the patch 28 may be constructed of paper or any other suitable material, such as any other suitable material from which bags or portions thereof may be formed.

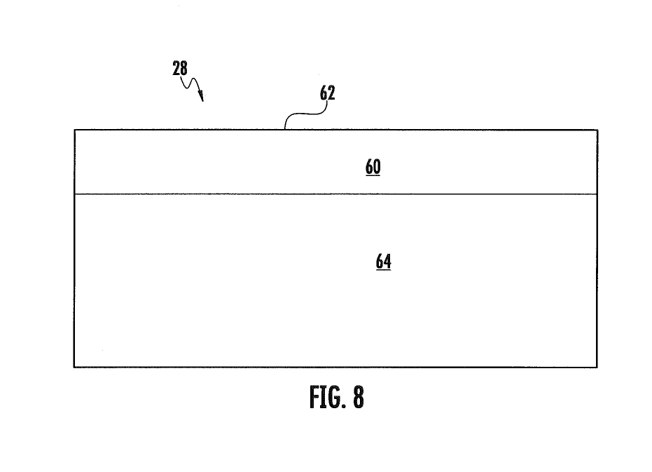

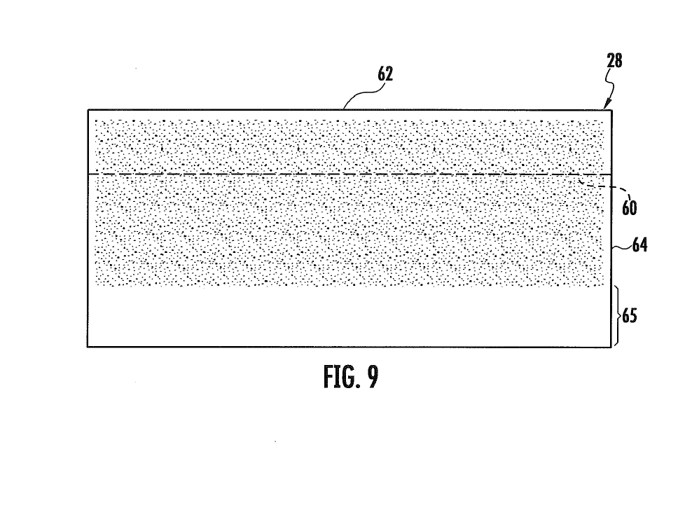

FIG. 8 is isolated top plan view of the cuffed patch 28. FIG. 9 is a bottom plan view of the cuffed patch 28, wherein adhesive material upon the underside of the cuffed patch is schematically illustrated by stippling in FIG. 9. Referring to FIG. 9, the predetermined pattern of adhesive material may be applied to the cuffed patch 28 prior to mounting the cuffed patch to the front, left and rear end flaps 50, 54, 56. The adhesive material may be of any suitable type, such as types conventionally used in the manufacture of paper bags, and the adhesive material may be applied in any suitable manner, such as by way of any suitable technique that is conventionally used in the manufacture of paper bags. The adhesive material may extend continuously, or intermittently, in the area of the adhesive pattern. The cuff 60 is hidden from view in FIG. 9, but is schematically illustrated by a dashed line. As shown in FIG. 9, the adhesive material does not cover a marginal portion 65 of the base portion 64. A portion of the marginal portion 65 of the base portion 64 of the patch 28 is also seen in FIG. 11.

In one embodiment, from the configuration shown in FIG. 7, the upper end 21 of the bag 20 may be closed by:
folding the front end flap 50 inwardly about the front upper lateral fold line 40 through substantially one hundred and eighty degrees, so that forward portions of the right and left end flaps 52, 54 are folded inwardly about the forward flap fold lines 45; and
then folding the rear end flap 56 inwardly about the rear lateral fold line 44 through substantially one hundred and eighty degrees, so that rearward portions of the right and left end flaps 52, 54 are folded inwardly about the rearward flap fold lines 45.

The lower end 23 of the bag may be closed in a similar manner, or the lower end 23 of the bag could be otherwise configured without departing from the disclosure.

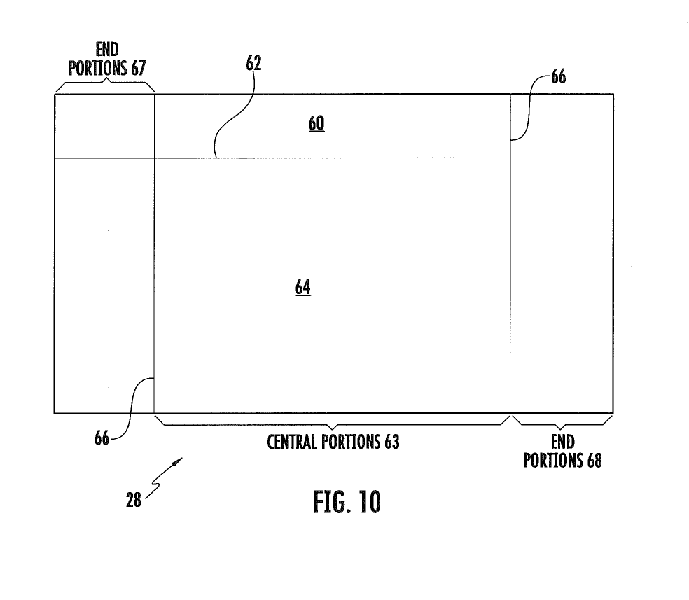

As a result of the closing of the upper end 21, opposite end sections/portions (FIG. 10) of the cuffed patch 28 are respectively folded about lateral fold lines 66 (FIG. 10) that are formed in the cuffed patch. The lateral fold lines 40, 44 of the body tube 30, flap fold lines 45 and lateral fold lines 66 of the patch 28 are respectively superposed with one another. Alternatively, the ends 21, 23 of the bag 20 may be closed in any other suitable manner.

FIG. 10 is an isolated plan view of the patch 28, wherein the patch is in a flat, unfolded configuration, and wherein the patch includes fold lines as if the patch together with the body tube 30 had been folded to form the bag 20 in its unfilled, flattened configuration, and then unfolded. Reiterating from above, the cuff 60 may be a marginal, relatively narrow, longitudinal strip of the patch 28 that is folded through substantially one hundred and eighty degrees about the patch's longitudinal fold line 62 relative to the base portion 64 of the patch. The base portion 64 may be a relatively wide, longitudinal strip of the patch 28. The cuff 60 and a corresponding, relatively narrow, longitudinal portion of the base portion 64 are in opposing face-to-face relation (e.g., face-to-face contact) with respect to one another when the patch 28 is in its cuffed configuration. The patch's cuff 60, longitudinal fold line 62, and base portion 64 may each extend between opposite ends of the patch 28.

In the embodiment shown in FIG. 10, the pair of spaced apart lateral fold lines 66 in the patch 28 extend across (e.g., perpendicular to) the patch's longitudinal fold line 62 and divide the patch into a central portion 63 and end portions 67, 68. The end portions 67, 68 are respectively foldably connected to opposite edges of the central portion 63 by the lateral fold lines 66. The end portions 67, 68 are folded about the lateral fold lines 66 so that the end portions 67, 68 are in opposing face-to-face relation (e.g., face-to-face contact) with the central portion 63.

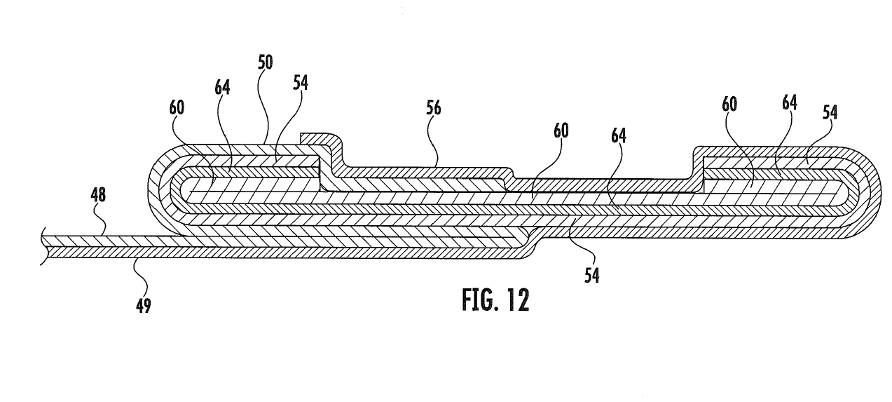

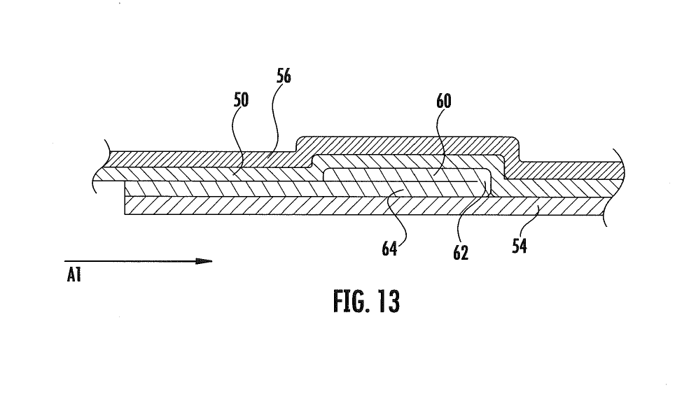

More specifically, the patch's lateral fold lines 66 divide each of the cuff 60, base 64 and longitudinal fold line 62 so that each is included in the central portion 63 and end portions 67. 68. As best understood with reference to the schematic cross-sectional views of FIGS. 12 and 13, as a result of the above-discussed folding that includes the end portion s 67, 68 being folded about the lateral fold lines 66, the end portions 67, 68 of the cuff 60 are in opposing face-to-face relation (e.g., face-to-face contact) with the central portion 63 of the cuff. In addition, the cuff is positioned (e.g. sandwiched) between:
a marginal portion of the central portion 63 of the base 64, and
marginal portions of the end portions 67, 68 of the base 64.

In addition, some of the end portions 67, 68 of the base 64 are in opposing face-to-face relation (e.g., face-to-face contact) with some of the central portion 63 of the base 64. The patch 28 and cuff 60 could be otherwise shaped, arranged, and/or configured without departing from the disclosure.

In the embodiment illustrated in the drawings, adhesive material typically is not positioned between the surfaces of the patch 28 that are in opposing face-to-face relation with respect to one another. As an optional result, after the valve bag 20 is fully formed, one or more unsealed passageways or channels may be defined between respective surfaces of the patch 28 that are in opposing face-to-face relation with respect to one another, wherein these passageways or channels may be operative for allowing air to vent outwardly therethrough, from the interior of the bag 20 to outside of the bag, such as while the bag is being filled via the valve tube 22. During any such venting or in other suitable circumstances, the cuff 60, such as a portion of the cuff, may open slightly (e.g., by way of the cuff pivoting slightly about the longitudinal fold line 62 relative to the base portion 64), so that the cuff at least partially/further obstructs these passageways or channels in a manner that seeks to restrict any leakage of solid material from the upper end of the bag 20, such as while the bag is being filled via the valve tube 22. That is, the cuff 60 may trap solid material to restrict the solid material from sifting or otherwise escaping from the bag 20 but still allow air to pass through the material of the cuff and vent the bag 20. Alternatively and/or in addition, the cuffed patch 28 reinforces the upper end of the bag 20, such as in a manner that seeks to prevent the upper end 21 of the bag 20 from rupturing or otherwise “blowing out,” such as while the bag is being filled via the valve tube 22.

In one embodiment, the patch 28 comprises a material (e.g., paper) that is permeable to air but prevents solid from passing through the material. Alternatively, the patch 28 could comprise material that is substantially impermeable to air and solids without departing from the disclosure.

According to one embodiment of the disclosure, a method of forming a bag includes forming the sleeve or body tube 30 having an interior from a web of multi-ply material. Thereafter, the method includes defining the plurality of upper and lower end flaps 50, 52, 54, 56 and slits 46 in the sleeve 30 through a cutting process. The upper end flaps 50, 52, 54, 56 and lower end flaps may be folded to form respective upper and lower ends 21, 23 of a bag 20. While folding the plurality of upper end flaps 50, 52, 54, 56, or at substantially the same time, the method includes positioning the valve 22 on the upper end 21. The valve 20 can receive flowable material for filling the bag 20. Additionally, the method includes positioning the patch 28 on the upper end 21 and opposite from the valve 22. The patch restricts leakage of material flowing through the valve 22, and includes the cuff 60.

In one embodiment, the method additionally includes applying adhesive to the plurality of upper end flaps 50, 52, 54, 56 to form the upper end 21. The patch 28 and valve 22 are attached to the upper end 21 by the adhesive. As described above, the patch 28 comprises the base portion 64 and the cuff 60 is foldably connected to the base portion 64 at fold line 62. The fold line 62 is orthogonal to a direction of flow of material flowing through the valve 22. Furthermore, the valve 22 has a central axis X_{C} in alignment with a flow of material (arrow A1) passing through the valve passageway 25.

In one embodiment, the method additionally includes folding the cuff 60 at the fold line 62 to be face-to-face contact with the base portion 64. As folded, the cuff 60 is positioned transverse to the direction of flow of material (arrow A1). Additionally, the cuff is positioned transverse to the central axis X_{C} of the valve 22. Furthermore, the fold line 62 is substantially orthogonal to the central axis X_{C} of the valve 22. Moreover, the patch 28 includes the first end portion 67 and the second end portion 68 arranged opposite to one another. The first end portion 67 is foldably connected to the base portion 64 at the second fold line 66 and the second end portion 68 is foldably connected to the base portion at the third fold line 66. According to one embodiment, the first and second end portions 67, 68 comprise two layers of material folded at a respective second fold line and third fold line 66.

In the illustrated embodiment, the bag 20 is generally formed of a multi-ply material that comprises at least three layers of flexible material and the upper end 21 is formed of substantially overlapped layers of the multi-ply material adhered to the patch 28 and the cuff 60. For example, the upper end 21 may be formed from a plurality of substantially overlapped layers of material that comprise a first layer defining an interior surface of the bag 20, a second layer adhered to the first layer defining a base portion 64 of the patch 28, a third layer partially overlapping the second layer defining the cuff 60 of the patch 28, and at least one layer adhered to the second and third layers defining an exterior surface of the bag 20. Although described above as including particular steps for forming the bag 20, it is understood that any of the above process steps may be altered, omitted, or otherwise configured without departing from the disclosure. The bag 20 could be formed of less than three layers of material or more than three layers of material without departing from the scope of the disclosure.

The bag 20, valve tube 22, patch 28, body tube 30 and/or adhesive material may be configured differently than discussed above; they may be configured in any suitable manner. For example and alternatively, adhesive material may positioned between at least some of the surfaces of the patch 28 that are generally in opposing face-to-face relation with respect to one another, so that those surfaces are adhered to one another. The folding discussed above in the context of closing the ends of the bag 20 may be performed manually and/or using suitable automated folding machine(s).

In accordance with the exemplary embodiment of the present disclosure, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The above embodiments may be described as having one or panels adhered together by glue. The term “glue” is intended to encompass all manner of adhesives commonly used to secure bag features or layers of material.

The foregoing description of the disclosure illustrates and describes various embodiments of the present disclosure. As various changes could be made in the above construction without departing from the scope of the disclosure, it is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure without departing from the scope of the disclosure.

What is claimed is:

1. A bag for containing flowable material, the bag comprising:
an upper end, the upper end being at least partially closed;
a lower end opposite the upper end, the lower end being closed;
a valve in the upper end, the valve being configured to receive flowable material for filling the bag; and
a patch in the upper end and opposite from the valve, the patch being configured to restrict leakage of material flowing through the valve, wherein the patch includes a cuff.

2. The bag of claim 1, wherein the upper end and lower ends are closed with adhesive, and wherein the patch and valve are attached to the upper end by the adhesive.

3. The bag of claim 1, wherein the patch comprises base portion and the cuff is foldably connected to the base portion at a fold line.

4. The bag of claim 3, wherein the fold line is orthogonal to a direction of flow of material flowing through the valve.

5. The bag of claim 4, wherein the cuff is folded at the fold line and is in face-to-face contact with the base portion.

6. The bag of claim 1, wherein the valve has a central axis in alignment with a flow of material passing through the valve.

7. The bag of claim 6, wherein the cuff is arranged transverse to the direction of flow of material.

8. The bag of claim 6, wherein the cuff is arranged transverse to the central axis of the valve.

9. The bag of claim 6, wherein the patch comprises a base portion, the cuff is foldably connected to the base portion a fold line, and the fold line is substantially orthogonal to the central axis of the valve.

10. The bag of claim 9, wherein the fold line is a first fold line and the patch includes a first end portion and a second end portion arranged opposite to one another, the first end portion is foldably connected to the base portion at a second fold line and the second end portion is foldably connected to the base portion at a third fold line.

11. The bag of claim 10, wherein the second fold line and the third fold line are substantially parallel to the direction of flow of material through the valve.

12. The bag of claim 10, wherein the second fold line and the third fold line are substantially parallel to a central axis of the valve.

13. The bag of claim 10, wherein the first and second end portions comprise two layers of material folded at a respective second fold line and third fold line.

14. The bag of claim 1, wherein the bag is formed of a multi-ply material.

15. The bag of claim 14, wherein the multi-ply material comprises at least three layers of flexible material.

16. The bag of claim 14, wherein the upper end is formed from substantially overlapped layers of the multi-ply material that at least partially envelope the patch and cuff

17. The bag of claim 14, wherein the upper end is formed from substantially overlapped layers of the multi-ply material adhered to the patch and cuff

18. The bag of claim 1, wherein the upper end is formed from a plurality of substantially overlapped layers of material.

19. The bag of claim 18, wherein the plurality of substantially overlapped layers of material comprise:
a first layer defining an interior surface of the bag;
a second layer adhered to the first layer defining a base portion of the patch;
a third layer partially overlapping the second layer defining the cuff of the patch; and
at least one layer adhered to the second and third layers defining an exterior surface of the bag.

20. The bag of claim 1, further comprising a sleeve defining the interior of the bag, a plurality of upper end flaps at the upper end of the bag, and a plurality of lower end flaps at the lower end of the bag.

21. The bag of claim 20, further comprising adhesive applied to the plurality of upper end flaps to form the upper end of the bag and adhesive applied to the plurality of lower end flaps to form the lower end of the bag.

22. The bag of claim 21, wherein the patch and valve are adhesively secured to the plurality of upper end flaps.

23. A method of forming a bag, comprising:
forming a sleeve having an interior from a web of multi-ply material;
defining a plurality of upper and lower end flaps in the sleeve through a cutting process;
folding the upper end flaps to form an upper end of the bag;
folding the lower end flaps to form a lower end of the bag;
positioning a valve on the upper end, the valve being configured to receive flowable material for filling the bag; and
positioning a patch on the upper end and opposite from the valve, the patch being configured to restrict leakage of material flowing through the valve, wherein the patch includes a cuff.

24. The method of claim 23, further comprising applying adhesive to the plurality of upper end flaps to form the upper end, and wherein the patch and valve are attached to the upper end by the adhesive.

25. The method of claim 23, wherein the patch comprises base portion and the cuff is foldably connected to the base portion at a fold line.

26. The method of claim 25, wherein the fold line is orthogonal to a direction of flow of material flowing through the valve.

27. The method of claim 26, further comprising folding the cuff at the fold line and to be face-to-face contact with the base portion.

28. The method of claim 23, wherein the valve has a central axis in alignment with a flow of material passing through the valve.

29. The method of claim 28, wherein the cuff is positioned transverse to the direction of flow of material.

30. The method of claim 28, wherein the cuff is positioned transverse to the central axis of the valve.

31. The method of claim 28, wherein the patch comprises a base portion, the cuff is foldably connected to the base portion a fold line, and the fold line is substantially orthogonal to the central axis of the valve.

32. The method of claim 31, wherein the fold line is a first fold line and the patch includes a first end portion and a second end portion arranged opposite to one another, the first end portion is foldably connected to the base portion at a second fold line and the second end portion is foldably connected to the base portion at a third fold line.

33. The method of claim 32, wherein the first and second end portions comprise two layers of material folded at a respective second fold line and third fold line.

34. The method of claim 23, wherein the bag is formed of a multi-ply material that comprises at least three layers of flexible material, the upper end is formed of substantially overlapped layers of the multi-ply material adhered to the patch and the cuff.

35. The method of claim 23, wherein the upper end is formed from a plurality of substantially overlapped layers of material that comprise:
a first layer defining an interior surface of the bag;
a second layer adhered to the first layer defining a base portion of the patch;
a third layer partially overlapping the second layer defining the cuff of the patch; and
at least one layer adhered to the second and third layers defining an exterior surface of the bag.

36. A bag for containing flowable material, the bag comprising:
a partially closed upper end;
a closed lower end opposite the partially closed upper end;
a valve in the upper end, the valve having a central axis aligned with a direction of flow of material for filling the bag; and
a patch in the upper end and opposite from the valve, the patch being configured to restrict leakage of the flow of material, wherein the patch includes a base portion and a cuff foldably connected to the base portion at a fold line, and wherein the fold line is arranged transverse to the central axis of the valve.

37. The bag of claim 36, wherein the fold line is a first fold line and the patch includes a first end portion and a second end portion arranged opposite to one another, the first end portion is foldably connected to the base portion at a second fold line and the second end portion is foldably connected to the base portion at a third fold line.

38. The bag of claim 37, wherein the second fold line and the third fold line are substantially parallel to the direction of flow of material through the valve.

39. The bag of claim 37, wherein the second fold line and the third fold line are substantially parallel to the central axis.

40. The bag of claim 38, wherein the first and second end portions comprise two layers of material folded at a respective second fold line and third fold line.
